(19) United States
(12) Patent Application Publication
(10) Pub. No.: US 2014/0025743 A1
(43) Pub. Date: Jan. 23, 2014

(54) Apparatus and Method for Collaborative Content Browsing

(71) Applicant: Higher Challenge, Inc., Pleasanton, CA (US)

(72) Inventors: Jesse Chou, Dublin, CA (US); Pamela Krueger, Tiburon, CA (US)

(21) Appl. No.: 13/945,857

(22) Filed: Jul. 18, 2013

Related U.S. Application Data
(60) Provisional application No. 61/673,175, filed on Jul. 18, 2012.

(51) Int. Cl. H04L 29/08

(52) U.S. Cl. CPC H04L 67/22
USPC 709/204

(57) ABSTRACT

Methods utilizing social networks and their content browsing history and other attributes are utilized for selecting and sorting content when servicing content requests. Dynamically-formed virtual profiles of a user may also be used for collaborative content browsing. It thus combines the “traditional” keyword and relevancy with the preferences from each user's social network browsing history for content selection and sorting. Mathematical set and its properties to are used to describe some of the applications and implementations.

### PRIORITY CLAIM

This application claims priority from a U.S. provisional application entitled: “Apparatus and Method for Collaborative Content Browsing,” filed on Jul. 18, 2012 and having the patent application No. 61/673,175. This provisional application is incorporated herein by reference.

### FIELD OF THE INVENTION

The present invention generally relates to methods for browsing content as may be provided by web services (e.g. web server) and, more particularly, to methods for collaborative browsing of content using information from social networks as well as content browsing history to generate targeted content.

### BACKGROUND

Content selection and sorting for content browsing is becoming more important with the shortened time span people have as well as the explosive volume of content. These are the areas of how content selection and sorting is used to target user interests. For example, search engines rank content based on popularity and relevance. They check the titles, internal links, external links, back links (external links to the content) of the contents, and back link web site rankings among others. They all use crawlers going through different contents on the web, build indices, and store them for the user browsing requests. In another example, audience/behavior targeting technologies allows owners or publishers of web contents to target the users based on when the visits happen, the contents they visit, the amount of time they spend on contents, the links they click on, the searches they make and the things that they interact with, their geographic information, demographics or contextual web page content. Therefore audiences are segmented based on users with similar profiles. Users will then be shown the more targeted content which should get more visitors' interests. However, these techniques are generally based on the particular user's behavior; it does not take into consideration of the people affiliated with the user, for example, other users from a particular user's social network.

### SUMMARY OF THE INVENTION

The present invention describes methods utilizing social networks and their content browsing history and other attributes for selecting and sorting content when servicing content requests. The invention also presents usage of dynamically-formed virtual profiles for collaborative content browsing where it utilizes the social network connections of the user. It thus combines the “traditional” keyword and relevancy with the preferences from each user's social network browsing history for content selection and sorting. The invention utilizes mathematical set and its properties to describe some of the applications and implementations.

### DESCRIPTION OF THE DRAWINGS

FIG. 1 illustrates an intersection of three sets.

FIG. 2 illustrates an embodiment of a multi-party collaborative browsing system;

FIG. 3 illustrates a process of continuously updating of the interest attribute edges of an embodiment of the multi-party collaborative browsing system;

FIG. 4 illustrates an embodiment of a multi-party collaborative browsing system with socially-connected virtual profiles for content selection and sorting;

FIG. 5 illustrates an embodiment of a multi-party collaborative browsing system with socially-connected virtual profiles for content selection and sorting (with or without a user-side virtual profile On/Off switch;

FIG. 6 shows a process flow for multi-party collaborative browsing flow;

FIG. 7 illustrates a flow chart for a collaborative browsing system for multi-level targets; and

FIG. 8 shows a collaborative browsing system for target and path generation.

### DETAILED DESCRIPTION OF THE PREFERRED EMBODIMENTS

Social network has its value and so is searching and browsing for Internet content. For collaboration while content browsing, social network could augment the keyword and (Google) page-rank based content selections and sorting.

To make this collaboration work, multi-way collaborative browsing methods are presented. These methods are independent of content types (even user profiles are a type of contents), where a user's social connections (e.g. Facebook social graph) are tapped to give certain contents a higher selection and sorting preference if other users in the immediate social network had previously browsed these contents. Thus it is possible to match a request to multiple types of contents, including the matching to another user.

Here, each content could have one or more interest attributes. Interest attributes can be generated from keywords and/or user tags. When serving content in response to user requests, one or more (links) edges are recorded for each user for each content request whether it's a search request or a follow-on click on a link inside certain content.

For example, a recorded link edge could be denoted as (A, B) when a user search request has an interest attribute A and then, from the search results, clicked on a content with an attribute B; or a user clicked on a link to content with attribute A, to get to content with attribute B.

Here, under a system utilizing this method, user browsing activities are recorded as edges. For each user browsing request, the user's social network is used to find the recorded edges from social friends' browsing history so as to select and sort the content results to better service the request based on friends' interests shown before.

One implementation of this selection and sorting process is to give the highest preference to the intersection of the edges from social friends' browsing history. The next preference will be the symmetric difference of the sets (union of the sets without the intersection of the sets) of edges from social friends' browsing history. Thereafter will be the rest of the contents based on keywords and relevancies.

One rational to use this socially connected interest attribute targeting is to target the interest of a user's browsing activity (search or follow-on click) with consideration of influences from the interests of the user's social friends, thus provide better content selection and sorting.

These methods could be used as an independent content selection and sorting mechanism for 3^{rd} party search engines, content services, or in conjunction with a content management/service system.

The methods of the present invention could be utilized to find potential targets (e.g. for sales and marketing leads) and the potential path to get to the targets. In this scenario, after certain targeted content is delivered to a user, this particular user can be identified as a 1^{st} level target if this user responded with positive activity or feedback, such as browsing the targeted content with a long enough period of time, continuing to click embedded link(s), or responding to an inquiry and other behaviors not enumerated here. When a user is identified as a target, the user's social graph with interest attribute edges will be processed to generate 2^{nd} level targets and the corresponding social paths. The list of 2^{nd} level targets and associated paths to this particular user can be used to promote certain targeted content. Also if the targeted content is delivered to a 2^{nd} level target, there could be a different set of activities/responses and behavior criteria to identify this user as a 1^{st} level target and tag this user as such.

Following the aforementioned edge notation, these recorded edges could be abstracted, using mathematical set properties, as Cartesian products of interest attribute objects. Thus the interest attributes are objects of sets.

Further, in the situation of user tags as interest elements, the edge could be just denoted as from itself to itself. For example, (A, A) would be such a notation, and if A is a user tag, this tells us there was probably a user tagging a tag A for this particular content.

Using the mathematical set notations makes the benefits of this method clearer. To illustrate in one application: for an interest edge denoted (X, Y), X is the starting element and Y is the ending element. The most influential group of edges are made up of the edges whose starting elements belongs to the intersection of the collective starting elements; whereas whose ending elements belongs to the intersection of the collective ending elements. The second most relevant group are the edges which have the starting element(s) from the intersection of the collective starting elements, but the ending elements are outside of the intersection of the collective ending elements.

Using Cartesian product property, since

(A∩ B)×(C∩ D)=(A×C)∩(B×D) [1]

Here Ax and By are the interest attributes to form the starting elements of the edges, in set A and B, for user I and J respectively from their browsing history, whereas Cx and Dy are the ending elements respectively. From the aforementioned Cartesian product property, the edge with starting element Ax and ending element Cx produces (Ax, Cx), whereas the edge with starting element By and ending element Dy produces (By, Dy). Thus the implementation could be approached from either way of the Cartesian product equation, depending on the context and convenience, to arrive at the same result such that the most socially relevant contents, which are in the set intersection, are sorted with higher preferences.

In one specific application of this method, the group of edges with the highest preferences is the intersection of the sets. And the next highest preference group is the rest of the sets, that is, the union without the intersection of the sets. To further utilize the mathematic set properties, symmetric difference of sets could be used recursively.

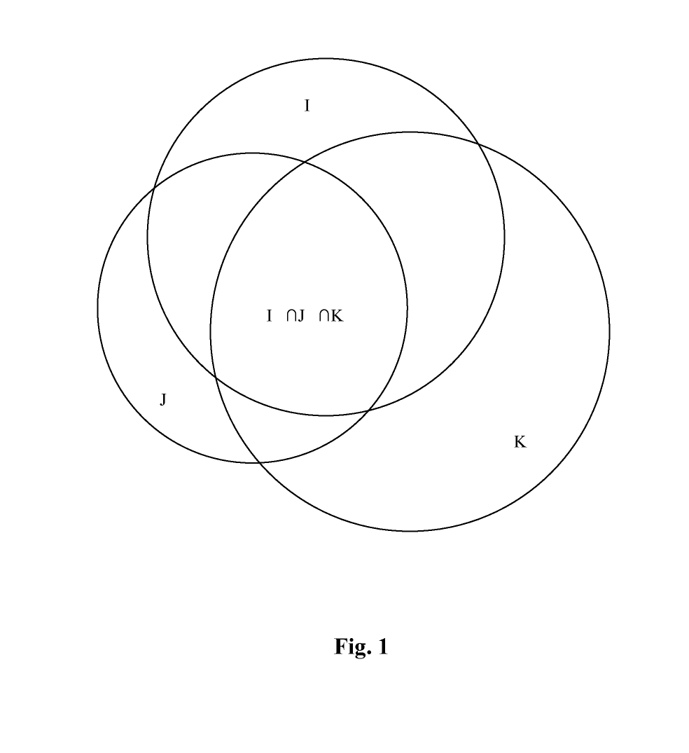

To demonstrate, FIG. 1 illustrates 3 sets of interest attribute edges: set I, J, and K. If an ON/OFF bit is attached to each edge, working on set I and J first, when there is a match of edges, the ON/OFF bit is flipped ON, otherwise it is OFF. Then all the edges with ON bit belong to the intersection, and the rest is the symmetric difference of these 2 sets. Recursively, we use the results of this operation to work with set K in the same way. The final result will give us 2 sets: one set is the intersection of all the sets and the other is the rest of the edges. Thus we have our sets of preferences to sort the result for the respective content request.

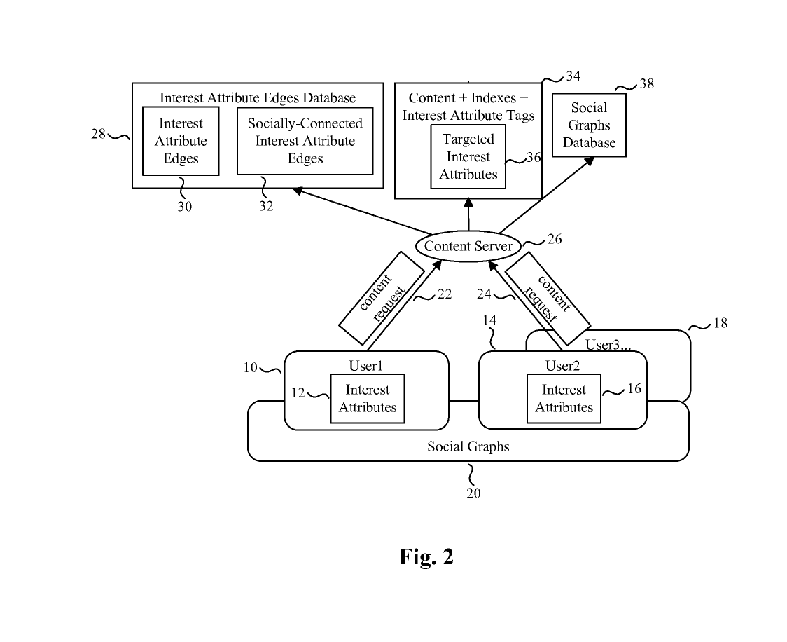

Referring to FIG. 2, a block diagram of a preferred embodiment of the present invention is illustrated. Here, a user (User1 10) may have a number of interest attributes 12 related to the particular application at hand. For example, if the present invention is used in an application to match an investor with one or more financial advisors (hereinafter, the financial advisor application), the investor (User1) may have a number of interest attributes, where these interest attributes may be generated with direct questions and answers with the user or it may be generated by observing the behavior of the user and the information requested and/or reviewed by the user. For example, if the user in visiting a website using an embodiment of the present invention is observed to request content related retirement planning, followed by 401k and social security, the content server 26 would then keep track of these items by generating one or more interest attribute edges 30 for User1 as follows: (User1, retirement planning), (retirement planning, 401k), and (401k, social security). These linked interest attribute edges 30 would be kept in an interest attribute edge database 28. In addition, additional socially connected interest attribute edges 32 can be generated from the users socially connected to User1 (see User2 14 and User3 16) from User1's social network 20 and kept in a social graphs database 38. For example, User1's social network 20 can be examined in which a social graph 20 relevant to the specific application at hand can be generated and stored in a social graph database 38, where each user in User1's social graph is analyzed and their respective interest attributes is determined and stored in the database 28.

For example, in examining the social network of User1, User2 and User3 are determined to be in User1 social network, and User2 and User3′s interest attributes are determined and stored in the database 28. Those interest attributes of the users that are socially connected with User1 can then be obtained from the database 28 as socially connected interest attribute edges 32. User1's interest attributes, the content, and socially connected interest attributes can be analyzed 34 to determine targeted interest attributes 36.

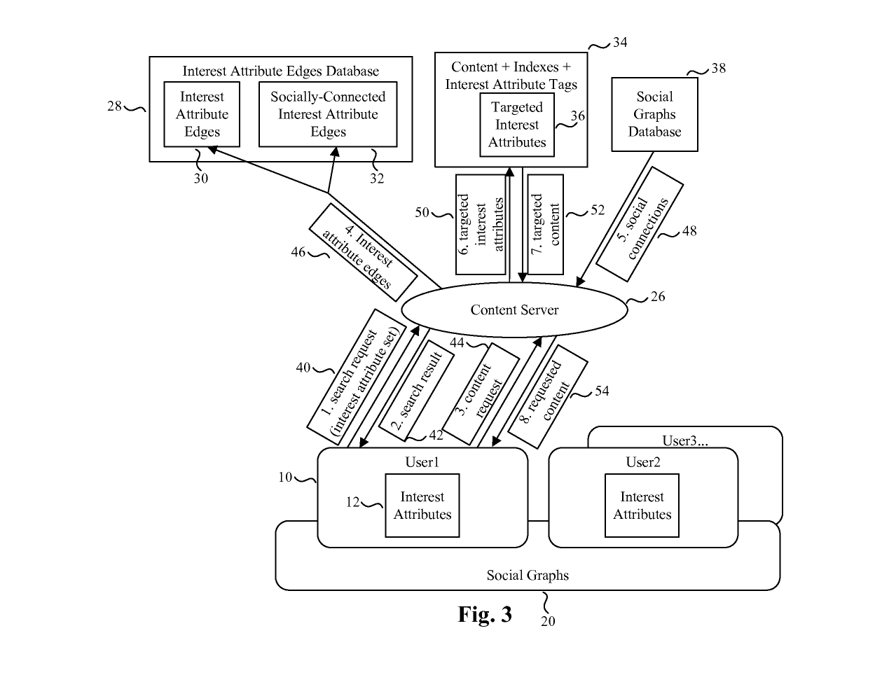

Referring to FIG. 3, a preferred process in continuously updating the interest attributes of the multi-party collaborative browsing system of the present invention is illustrated. Here, in a first step, User1 makes a search request 40, the content server 26 (which may be a widget on a particular webserver or a web service provider) in responding to the search request 40 provides search results 42 to User1. User1 in reviewing the search results 42 selects one or more of the contents 44 from the search results 42 and such one or more content requests 44 are sent to the content server 26. The content server 26 then obtains 46 the interest attributes 30 of User1, examines the social connections of User1 48, obtains 46 the socially-connected interest attributes 32 of User1 and generates targeted interest attributes 50, where the target interest attributes is associated with certain desired targeted content 52 and such targeted content 52 is obtained 52 and provided to User1 54.

For example, the content server 26 upon receiving the content request 44 from User1 looks through the interest attributes of User 1 (e.g. (User1, retirement planning), (retirement planning, 401k), and (401k, social security)). The content server 26 also fetches from the social graph database 38 to determine the other users in User1's social network. Here, it finds User2 and User3. Let's say User2 who happens to be a financial planner has a number of interest attributes related to retirement planning (e.g. (User2, retirement planning), (retirement planning, 401k)) and this particular interest attribute is associated with certain content related to User2; these content may be as provided by User2 or may have previously browsed by User2. In determining the intersection of the interest attributes of User1 and User2, here, the interest attributes (retirement planning and 401k) would intersect and content related to (retirement planning and 401k) from User2 (and other users) would be preferentially selected and provided to User1. In this manner, the content from other users' browsing history (or content that may be provided by other users) from the requesting user's social network would be preferentially provided to the requesting user.

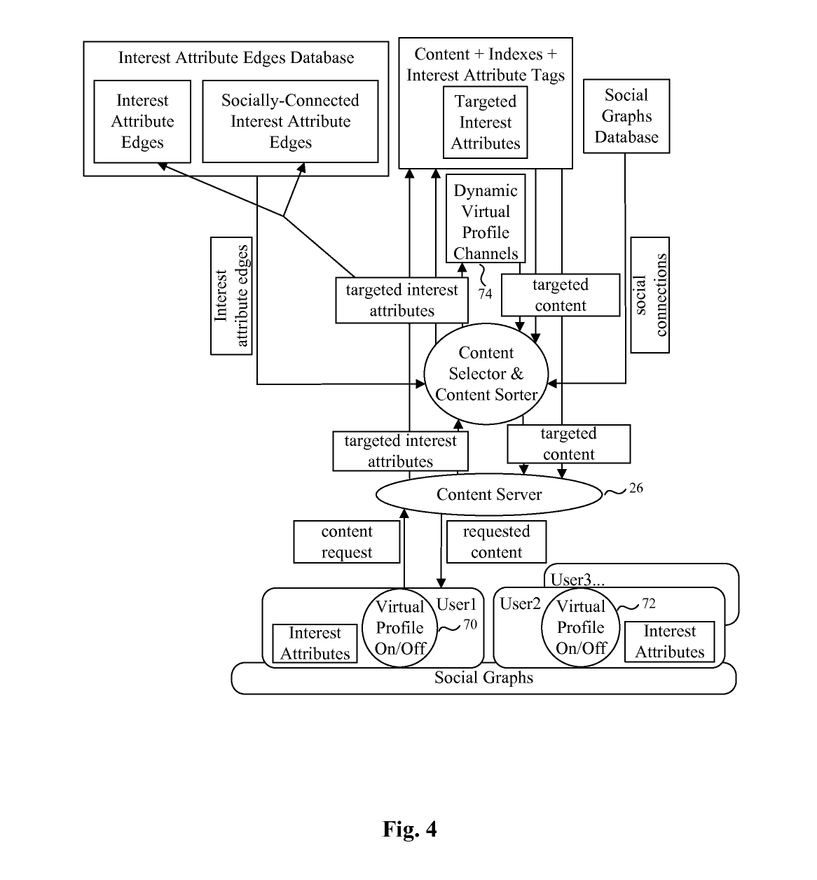

Referring to FIG. 4, as described above, the present methods could also be employed in conjunction with virtual profiles which are often used to set up content channels. In this scenario, the present methods can have the virtual profile dynamically adaptive to some specific social group based on everyone's browsing activities, e.g. for multiple users to perform collaborative browsing.

In this situation, each user has a virtual profile switch, 70 and 72, to turn the virtual profile browsing on or off. This switch could be built into the communication channel, such as chat software the users are using to communicate. When the switch is on for the users, the content server uses virtual profile for content selection and sorting. Yet in another application, the decision to use the virtual profile browsing could be made at the server level for collaboration 74. Thus the user-side virtual profile switch is not necessary.

Further yet with a different application, each user's immediate social connections could be used to dynamically form the basis of the virtual profile. The degree of social connections (direct friends, friends of a friend . . . ) could also be adjusted based on the application and desire.

So the virtual profile could be a preset profile or could be created dynamically when the collaborative browsing starts. During collaborative browsing, all parties could be served the identical page using the same virtual profile. Therefore the content results for all parties are synchronized for content search or request.

Further, content being browsed could be synchronized such that one party could be the leader which will do the browsing while the other will be the follower and his/her content will be checked, e.g. using a client-side agent software, with the server for refresh if the leader performed any action.

Moreover, the follower could give the leader “virtual control”, so the mouse and key actions are not real but rather simulating the leader's mouse and key actions—the follower in reality still has his/her control of mouse and key actions; but will see a “faked” mouse pointers as well as “faked” key stokes. This scenario is thus a web server based collaboration. This could be very useful in a teacher-student context. By the same token of taking into consideration of browsing histories of social friends, the user tags from a user's social friends' could also be given higher influence for content searches or requests.

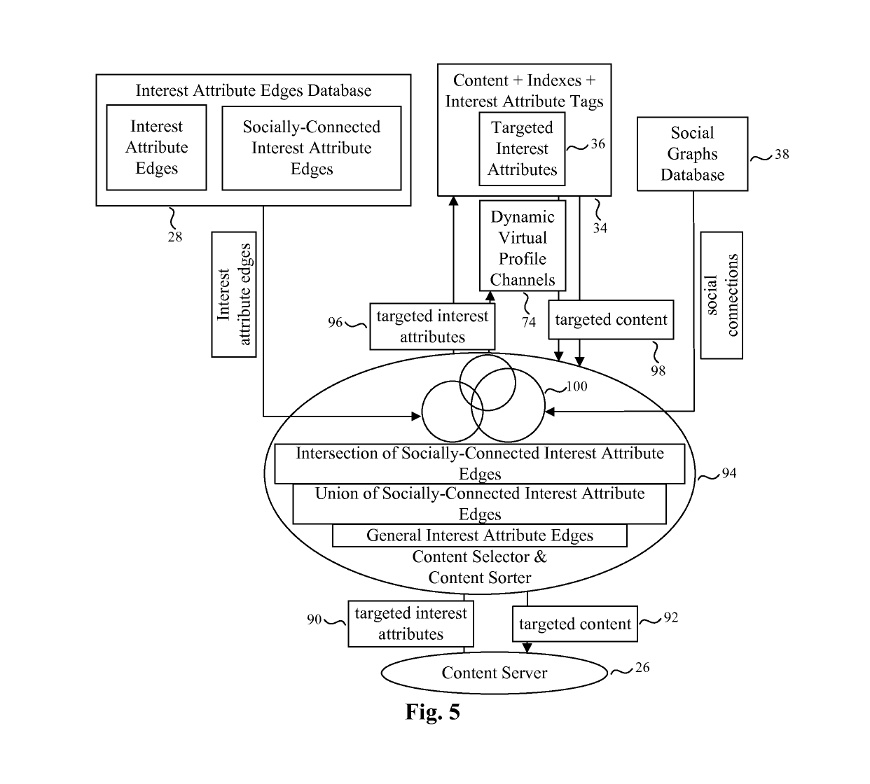

Referring to FIG. 5, the content server 26 provides targeted interest attributes 90 to the content selector & sorter 94 and targeted content 92 is generated and provided to the content server 26 to deliver to the requesting user. In generating the targeted content 92, the content selector & sorter 94, in using interest attributes, socially connected interest attributes, and general interest attributes and in taking the intersection of these sets and/or union of these sets (as described above) 100, generates the targeted content. The dynamic virtual profile channels 74 described above can be turned on or off in utilizing virtual profiles.

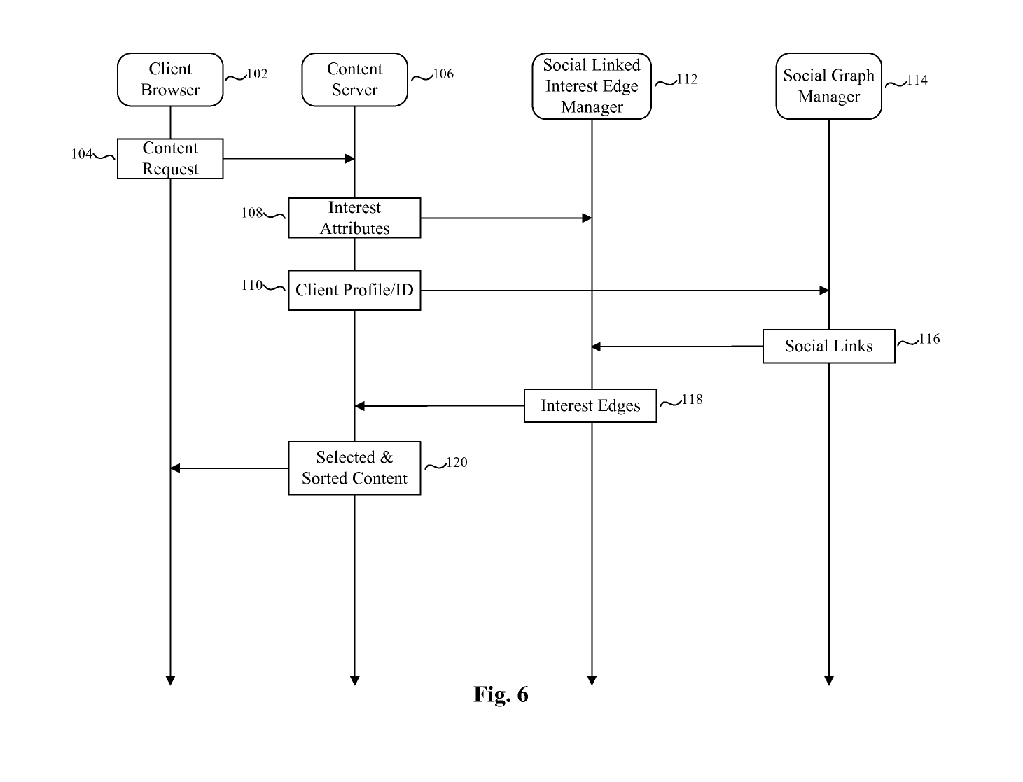

Referring to FIG. 6, a flow diagram of the preferred embodiment of the present invention is presented. Here, the user through its client browser 102 provides a content request 104 which is accepted by the content server 106 of the present invention. In turn, interest attributes 108 is generated and provided to the social-linked interest edge manager 112, and the user profile/ID (which could be a virtual profile) is delivered to the social graph manager 114. The social graph manager 114 determines the social links 116 for the user and delivers them to the social-linked interest edge manager 112 where the corresponding interest attribute edges 118 are determined and delivered to the content server 106, where it is selected and sorted 120 accordingly, the results of which are delivered to the client browser 102.

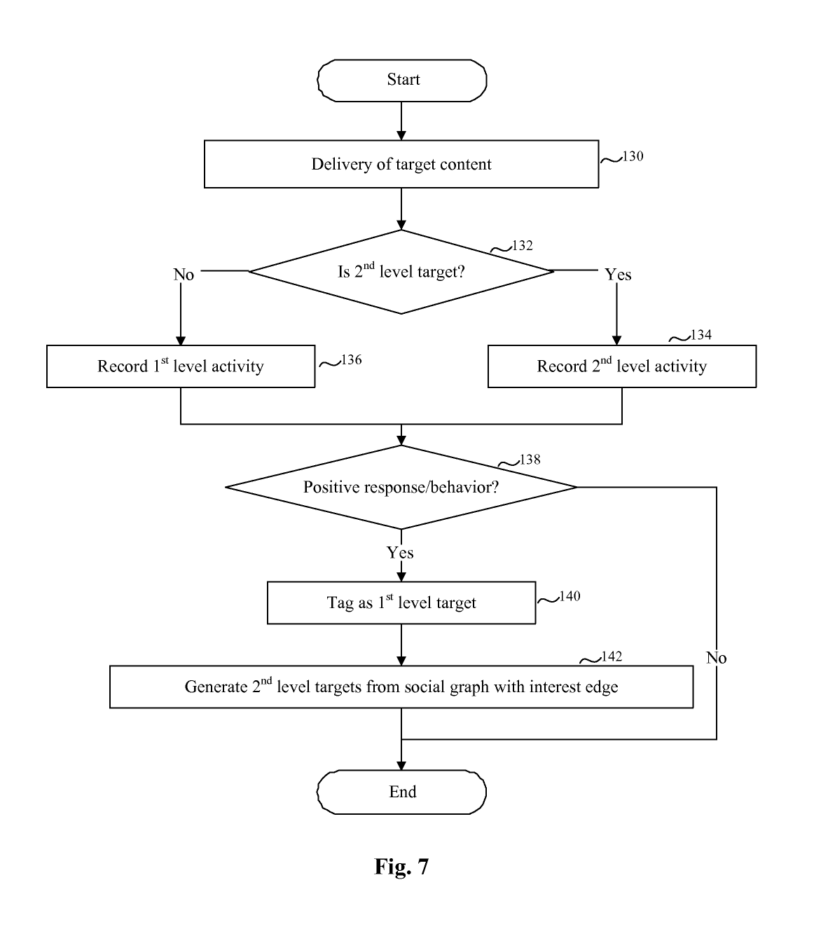

Referring to FIG. 7, a flow chart for determining multi-level targets is illustrated. Here, in the delivery of the targeted content 130 to the requesting user, the priority of the requesting user can be identified and categorized such that the requesting user having a high priority can be tracked and offered even more targeted content, special content, or special offers in order to provide maximum incentive for this high priority user to engage with the service offering provided by the web server or web service. Thus, here, the level of the requesting user is determined where whether the user is a 2^{nd} level target is first determined 132. If the user is a 2^{nd} level target, its activities are recorded as 2^{nd} level activities 134 and if the user is not a 2^{nd} lₑᵥₑl target, its activities are recorded as 1^{st} level activities 136. Then, the user is observed for positive response or positive behavior 138, which can be determined by the user clicking on certain types of content or responding certain types of questionnaire (e.g. answering a questionnaire with desired answers or further clicking on content that is identified as a positive response or behavior). If there is positive response or positive behavior, the user is tagged as a 1st level target 140 and 2^{nd} level targets can be generated from the social network of this user and they can be identified as 2^{nd} level targets 142. If there is no positive response or positive behavior, this process ends.

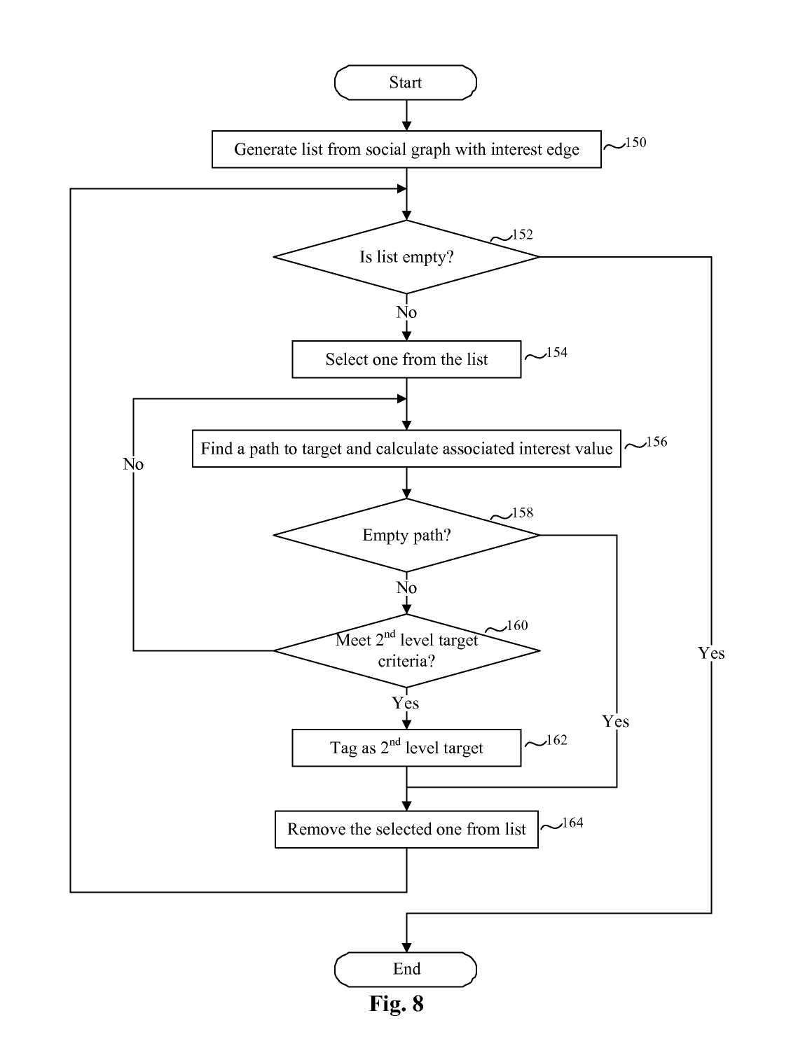

Referring to FIG. 8, a flow chart for generating a list from a user's social graph (social network) with interest edges 150 is illustrated. Here, if the social graph is empty 152, the process ends; otherwise a user from the social graph is selected from the list 154. Each of interest attributes (and other information) of this selected user is analyzed 156 recursively to determine if there is any relationship with the 2^{nd} level target criteria 160. If an interest attribute is related to the 2^{nd} level target criteria, the selected user is tagged as a 2^{nd} level target 162. This process continues for all the interest attributes of the selected user until all the interest attributes have been processed 158. Once all the interest attributes are processed, the selected user is removed from the list 164 and the next user from the social graph is selected and processed until all users in the social graph are processed 152.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for selecting and providing content to a browsing request of a requesting user, comprising the steps of:
generating one or more interest attributes for the requesting user;
generating one or more socially-connected interest attributes from each user in the requesting user's social network;
analyzing interest attributes of the requesting user and the socially-connected interest attributes to determine targeted interest attributes;
selecting content as a function of the targeted interest attributes; and
providing the selected content to the requesting user.

2. The method of claim 1 wherein if the selected content is a certain target content, the requesting user is identified as a targeted user.

3. The method of claim 2 wherein the behavior of the targeted user is monitored.

4. The method of claim 3 wherein the priority of the targeted user is identified and categorized as a function of the targeted user's behavior and response.

5. The method of claim 4 wherein the targeted user having a high priority is provided with special offers.

6. The method of claim 1 wherein in the analyzing step, mathematical set operations are used in generating the targeted interest attributes.

7. The method of claim 1 wherein a virtual profile is used for a user and interest attributes are generated as a function of the virtual profile.

8. The method of claim 1 wherein the users in the requesting user's social network are analyzed and identified as targeted users.

9. The method of claim 8 wherein the targeted users are selected as a function of its interest attributes and the targeted interest attributes.

10. The method of claim 1 wherein the selected content includes user profiles.

11. The method of claim 10 wherein the selected content is another user.

12. A method for selecting and providing content to a browsing request of a requesting user, comprising the steps of:
generating one or more interest attributes for the requesting user;
generating one or more socially-connected interest attributes from each user in the requesting user's social network;
analyzing interest attributes of the requesting user and the socially-connected interest attributes to determine targeted interest attributes;
selecting content as a function of the targeted interest attributes;
providing the selected content to the requesting user;
if the selected content is a certain target content, the requesting user is identified as a targeted user.

13. The method of claim 12 wherein the behavior of the targeted user is monitored.

14. The method of claim 13 wherein the priority of the targeted user is identified and categorized as a function of the targeted user's behavior and response.

15. The method of claim 14 wherein the targeted user having a high priority is provided with special offers.

16. The method of claim 12 wherein the behavior of the targeted user is monitored.

17. The method of claim 12 wherein the priority of the targeted user is identified categorized as a function of the targeted user's behavior and response.

18. A method for selecting and providing content to a browsing request of a requesting user, comprising the steps of:
generating one or more interest attributes for the requesting user;
generating one or more socially-connected interest attributes from each user in the requesting user's social network;
analyzing interest attributes of the requesting user and the socially-connected interest attributes to determine targeted interest attributes;
selecting content as a function of the targeted interest attributes; and
providing the selected content to the requesting user;
wherein if the selected content is a certain target content, the requesting user is identified as a targeted user and the behavior of the targeted user is monitored; and
wherein the priority of the targeted user is identified and categorized as a function of the targeted user's behavior and response and the targeted user having a high priority is provided with special offers.

19. The method of claim 18 wherein the users in the requesting user's social network are analyzed and identified as targeted users; and wherein the targeted users are selected as a function of its interest attributes and the targeted interest attributes.

20. The method of claim 19 wherein the selected content is another user.
